(19) United States
(12) Patent Application Publication
(10) Pub. No.: US 2003/0036406 A1
(43) Pub. Date: Feb. 20, 2003

(54) Built-in wireless LAN card for notebook computer

(76) Inventor: Ebony Huang, Hsin Chu Hsien (TW)

Correspondence Address: JACOBSON HOLMAN PLLC, 400 SEVENTH STREET N.W., SUITE 600, WASHINGTON, DC, 20004, US

(21) Appl. No.: 09/928,436

(22) Filed: Aug. 14, 2001

(51) Int. Cl. H04M 1/00

(52) U.S. Cl. 455/556; 455/557; 455/558

(57) ABSTRACT

A built-in wireless LAN card for notebook computer equips with a wireless transmission and receiving circuitry. This internal card structure reduces the cost of the package and connector of the external LAN card. This built-in LAN card for notebook computer also reduces the occupation of one expansion slot of the notebook computer.

### BACKGROUND OF THE INVENTION

I. Field of the Invention

This invention relates generally to a built-in wireless LAN (Local Area Network) card for notebook computer. The LAN card equips with a wireless transmission and receiving circuitry. This structure can avoid the extra expansion slot occupation by the external LAN card, it also reduces the cost of the package and connector of the external LAN card.

II. Description of the Prior Art

Heretofore, it is known the computer network in the office environment has to be linked together with wire, such arrangement not only increases the hardware expense but also costs money to decorate the office to hide the wire.

Most of the desktop computers are very bulky, the case body and monitor of a computer occupy most of the desk area, and the working area left is small. The simplest way to solve the bulky computer problem is to replace the desktop computer with a notebook computer. However the notebook computers still have to use wire to connect to the network, the wiring hassle mentioned above still exists. A better way to solve the problem is to use an external wireless LAN card b connected to expansion slot a1 of the notebook computer a, as shown in FIG. 3 and FIG. 4. The external wireless LAN card b has an antenna b1 to transmit and receive data, therefore the whole network can be connected together wirelessly.

However the external wireless LAN card b is connected to the notebook computer from outside, therefore the circuit board has to have an external package and a connector. Extra package and extra connector to manufacturer means extra cost and extra processes in manufacturing, the increasing overall cost.

To end-users, the external wireless LAN card b has to occupy one expansion slot a1 of the notebook computer a, this means the reduction of one add-on function for the notebook computer a, thus introduces the inconvenience.

### SUMMARY OF THE INVENTION

It is therefore a primary object of the invention to provide a built-in wireless LAN card for notebook computer. The LAN card equips with a wireless transmission and receiving circuitry. This internal card structure reduces the cost of the package and a connector of the external LAN card.

It is another object of the invention to provide a built-in wireless LAN card for notebook computer that reduces the occupation of the expansion slot of the notebook computer.

In order to achieve the objective set forth, a built-in wireless LAN card for notebook computer in accordance with the present invention comprises a wireless radio transmission circuitry in a built-in LAN card. The built-in LAN card consists of a circuit board with a bus connector on one side; the built-in LAN card connects to the mainboard of the notebook computer through the expansion slot with a flat cable.

### BRIEF DESCRIPTION OF THE DRAWINGS

The accomplishment of the above-mentioned object of the present invention will become apparent from the following description and its accompanying drawings which disclose illustrative an embodiment of the present invention, and are as follows:

FIG. 1 is a perspective view of the present invention;

FIG. 2 is a schematic diagram of a built-in LAN card in accordance with the present invention;

FIG. 3 is a perspective view of the prior art;

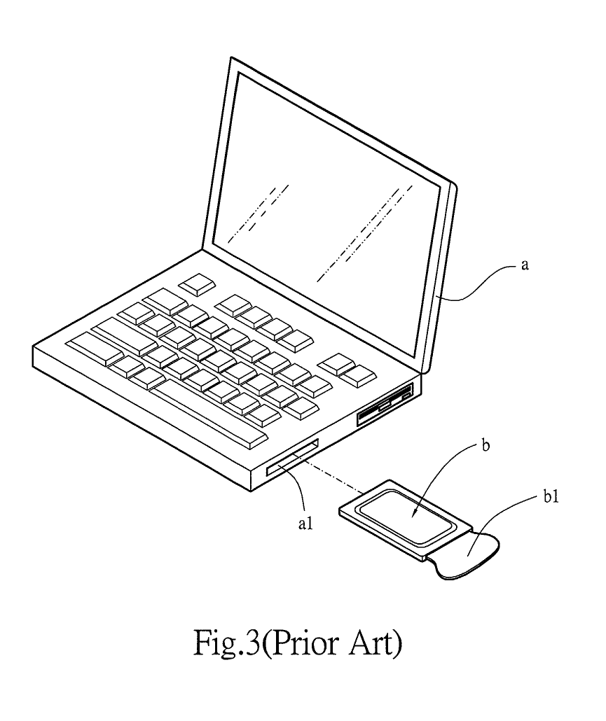

FIG. 4 is a schematic diagram of a built-in LAN card in accordance with the prior art.

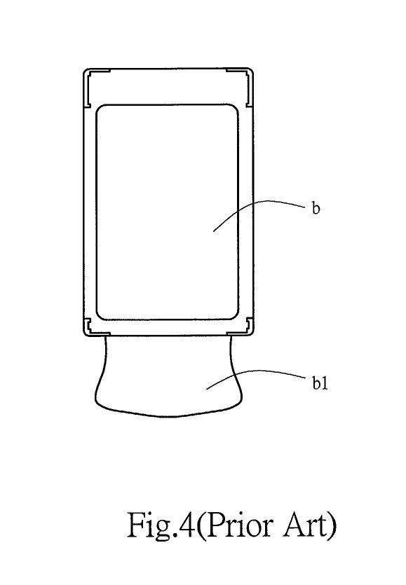

### DESCRIPTION OF THE PREFERRED EMBODIMENT

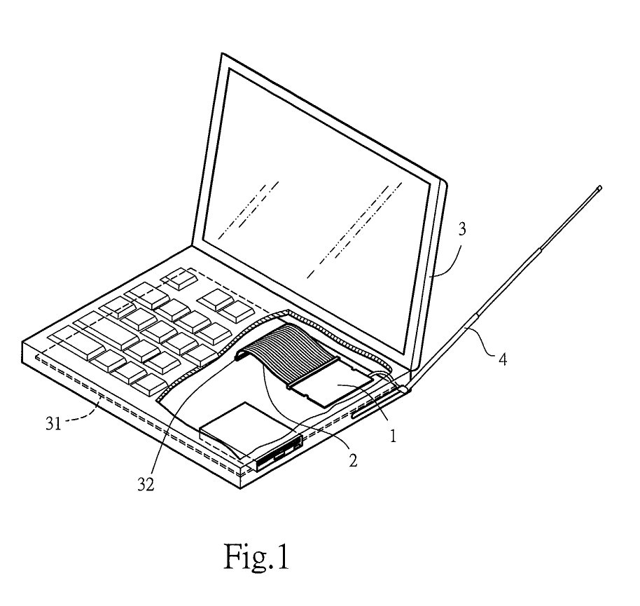

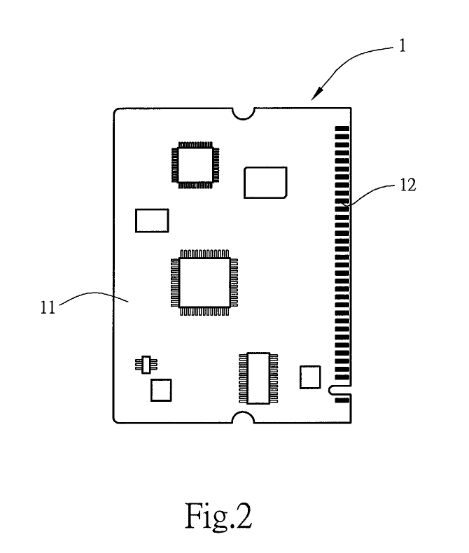

Referring to FIG. 1 and FIG. 2, the present invention is composed of a wireless radio transmission/receiving circuitry in a built-in LAN card 1. The built-in LAN card 1 consists of a circuit board 11 with a bus connector 12 on one side; the built-in LAN card 1 connects to the mainboard 31 of the notebook computer 3 through the expansion slot 32.

Based on above description, the built-in LAN card 1 equips with a wireless radio transmission/receiving circuitry. The built-in LAN card 1 connects to the expansion slot 32 of the mainboard 31 with a flat cable 2, this is how to avoid occupying the expansion slot of the notebook computer 3, the slot can be used for other functions.

The built-in LAN card 1 is installed inside of the notebook computer 3, therefore the built-in LAN card does not need external package and connector. The manufacturing cost can be lowered for better competition.

The built-in LAN card 1 can be a PCMCIA format LAN card.

An antenna 4 is installed on one side of the notebook computer 3; the antenna 4 connects to the built-in LAN card. The antenna 4 transmits and receives signals, data.

While a preferred embodiment of the invention has been shown and described in detail, it will be readily understood and appreciated that numerous omissions, changes and additions may be made without departing from the spirit and scope of the invention.

What is claimed is:

1. A built-in wireless LAN card for notebook computer comprising:
a built-in LAN card consisting of a circuit board with a bus connector on one side, said built-in LAN card connects to the mainboard of the notebook computer through the expansion slot with a flat cable,
a wireless radio transmission/receiving circuitry located on said built-in LAN card.

2. The built-in wireless LAN card for notebook computer recited in claim 1, wherein an antenna is installed on one side of the notebook computer, said antenna connects to said built-in LAN card to transmit and receive signals, data.

3. The built-in wireless LAN card for notebook computer recited in claim 1, wherein said built-in LAN card is a PCMCIA format LAN card.
